(19) United States
(12) Patent Application Publication
(10) Pub. No.: US 2008/0243966 A1
(43) Pub. Date: Oct. 2, 2008

(54) SYSTEM AND METHOD FOR MANAGING TEMPORARY STORAGE SPACE OF A DATABASE MANAGEMENT SYSTEM

(76) Inventors: RamanaKumari M. Croisettier, Morgan Hill, CA (US); Paramesh S. Desai, San Jose, CA (US); James Z. Teng, San Jose, CA (US)

Correspondence Address: KUNZLER & MCKENZIE;ATTORNEYS AT LAW, SUITE 600, 8 EAST BROADWAY, SALT LAKE CITY, UT, 84111, US

(21) Appl. No.: 11/695,459

(22) Filed: Apr. 2, 2007

(51) Int. Cl. G06F 17/30

(52) U.S. Cl. 707/206; 707/E17.005

(57) ABSTRACT

A method and system to manage temporary storage space of a relational database management system by receiving a data segment allocation request from an application, allocating a data segment to the application, marking the data segment as allocated in a space map page, and indicating a usage status of the data segment. The method also includes receiving a mass delete command from the application, indicating reception of the mass delete command in a table-related control block, and marking the data segment as unavailable in the space map page. The method may also include indicating reception of the mass delete commit command in the table-related control block to enable the application to reuse the data segment.

### BACKGROUND OF THE INVENTION

1. Field of the Invention

This invention relates to database management systems and methods and more particularly to systems and methods for managing the temporary storage space of a database management system.

2. Description of the Related Art

Among the many important qualities of a database management system is an ability to efficiently manage temporary storage. Managing temporary storage includes allocating storage space (also referred to as data segments or segment blocks) to users or applications that require temporary storage space. Another objective is to enable the user or application to issue and commit mass delete commands or mass delete rollback commands corresponding to temporary tables without unduly burdening or slowing the reuse or reallocation of storage space.

Some database management systems manage temporary storage space by using a unique object identifier approach. Under this approach, when an application requests storage space (for example to create a temporary table), the application is assigned a unique object identifier to relate the storage space to the temporary table. When the application submits a request for a mass delete a special lock based on the unique object identifier is placed on the storage space to prohibit other applications from gaining access to the storage space. This protects the data in the storage space from being overwritten until the mass delete command can be committed or rolled back.

Though the unique object identifier approach enables temporary storage space management, certain problems exist. For example, when the number of applications increase so does the demand for more unique object identifiers. Often, database management systems implementing the unique object identifier approach are unable to satisfy the demand for more unique object identifiers thereby undermining the database management system efficiency and effectiveness in serving a large number of applications.

To overcome the unique object identifier shortage, some database management systems implement a shared object identifier approach. However, using shared object identifiers also includes certain problems. For example, if user A and user B are using the same object identifier for different storage spaces and both user A and user B designate their respective storage spaces for mass delete, but only user A commits the mass delete, the storage space of user A will not be reusable until user B commits a mass delete because both users are using the same object identifier.

Also, if user A gets a mass delete lock using the same object identifier for user B, then user B is unable to perform a mass delete until the mass delete lock is removed. Naturally, this type of storage space lock-down is unnecessary and reduces the overall efficiency of the database management system. The probability of two applications sharing the same object identifier increases as the number of applications accessing temporary storage space increases.

From the foregoing discussion, applicants assert that a need exists for an improved system and method for managing temporary storage space of a database management system. Beneficially, such a system and method would optimize efficient temporary storage space management by providing a solution that can service many applications and that eliminates unnecessary storage space lock-downs.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a relational database management system in accordance with the present invention;

FIG. 2 is a schematic flow chart diagram illustrating one embodiment of a method for managing a data segment in accordance with the present invention;

FIG. 3 is schematic flow chart diagram illustrating one embodiment of a method for managing a data segment during a mass delete operation in accordance with the present invention;

FIG. 4 is a schematic flow chart diagram illustrating one embodiment of a method for managing a data segment during a mass delete rollback operation in accordance with the present invention;

FIG. 5 is a schematic flow chart diagram illustrating one embodiment of a method for deallocating a data segment in accordance with the present invention; and

FIGS. 6A-6I are text diagrams illustrating one embodiment of a space map page in various states of usage.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as a processor and memory device, field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code lines, among different programs, and across several memory devices. Similarly, operational data may be identified and illustrated herein within modules and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware processors and memory, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

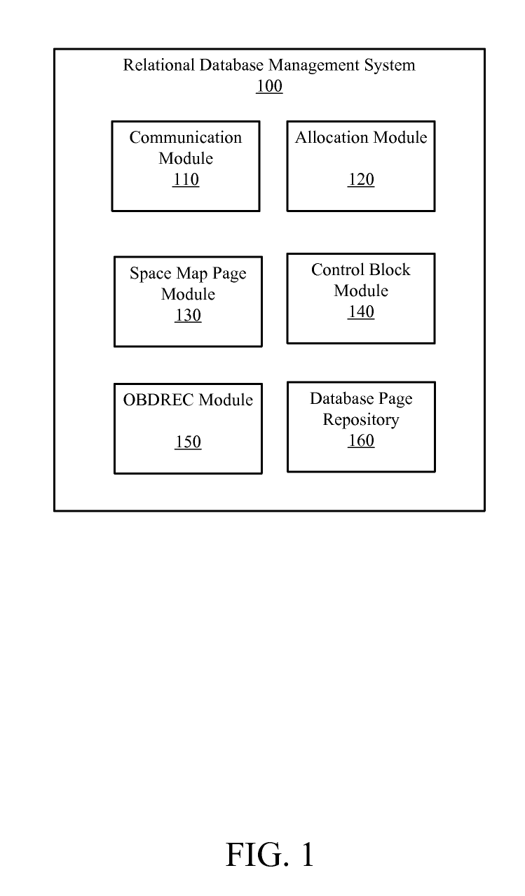

FIG. 1 is a block diagram illustrating one embodiment of a relational database management system 100 in accordance with the present invention. The depicted system 100 includes a communication module 110, an allocation module 120, a space map page module 130, a control block module 140, an OBDREC module 150, and a database page repository 160. The components of the system 100 cooperate to manage the temporary storage space of the database management system 100.

The communication module 110 receives a data segment allocation request from an application. In response thereto, the allocation module 120 allocates a data segment to the application. Allocating the data segment to the application may include enabling the application to write data to the data segment. Allocating the data segment to the application may also include prohibiting the data segment from being allocated to a different application so long as the data segment is allocated to the application.

The data segment may correspond to one or more database pages in the database page repository 160. Indeed reference to a data segment may include a reference to the database pages corresponding to the data segment as well. In some embodiments, the application uses the data segment to create a temporary object such as a temporary table. In some embodiments, the application may request multiple or additional data segments to create or add to a temporary table.

The space map page module 130 manages a space map page that indicates particular data segments that have been allocated to the application. In certain embodiments, the space map page is a database page in the database page repository 160. In certain embodiments, the space map page includes all data segments that can be allocated. The space map page module 130 may also store a usage status of the data segment allocated to the application. For example, in some embodiments, if the application creates a temporary table using the data segment, the amount of the data segment used to create the temporary table is represented in the space map page.

The communication module 110 may receive a mass delete command from the application corresponding to the data segment. In the depicted embodiment, the control block module 140 indicates the reception of the mass delete command in a table-related control block. In some embodiments, the table-related control block maintains a log of commands received from the application regarding the temporary table created using the data segment. In some embodiments, the table-related control block resides in a volatile memory (not shown) of the database management system 100. Indicating the mass delete commands that have been received in a table-related control block creates a repository of commands from which the space map page module 130 may retrieve information used to update the space map page.

The space map page module 130 marks the data segment corresponding to the mass delete command as unavailable in order to prohibit the application from using the data segment until the mass delete command is committed or rolled back. In certain embodiments, the availability or unavailability of a data segment can be implied from the usage status represented by a bitmap. If a mass delete commit command is received from the application by the communication module 110, the control block module 140 indicates reception of the mass delete commit command in the table-related control block to enable the application to reuse the data segment. As such, even though the data segment is indicated as ‘unavailable’ in the space map page, because the table-related control block indicates the mass delete commit command, the application can reuse the entire data segment.

If, however, a mass delete rollback command is received from the application by the communication module 110, the control block module 140 indicates reception of the mass delete rollback command within the table-related control block. Further, the space map page module 130 restores the data segment with respect to the data segment to a pre-mass delete state to enable the application to continue using the data segment and work on the temporary object without losing and data. In this manner, the relational database management system 100 enables an application to gain access to data segments for the creation of a temporary table, in addition to request and commit or rollback mass delete commands without unnecessary storage space lock-downs.

In certain embodiments, the communication module 110 receives a deallocation request from the application. In response thereto, the allocation module 120 deallocates the data segment from the application. The space map page module 130 marks the data segment corresponding to the deallocation request as not allocated and unavailable. The space map page module 130 may also reset the usage status of the data segment to reflect no usage of the data segment. In certain embodiments, the database management system 100 may deallocate a data segment as described above in response to receiving a mass delete commit command from an application. Accordingly, the database management system 100 enables the deallocation and reallocation of database segments according to need.

In certain embodiments, the OBDREC (object descriptor record) module 150 maintains a table of attribute data corresponding to the temporary table created by the application. Maintaining attribute data may facilitate determining the first data segment for a given temporary table. The attribute data may include a variety of data including number of rows in the temporary table, number of columns in the temporary table, type of data in the temporary data fields, table anchor points, etc.

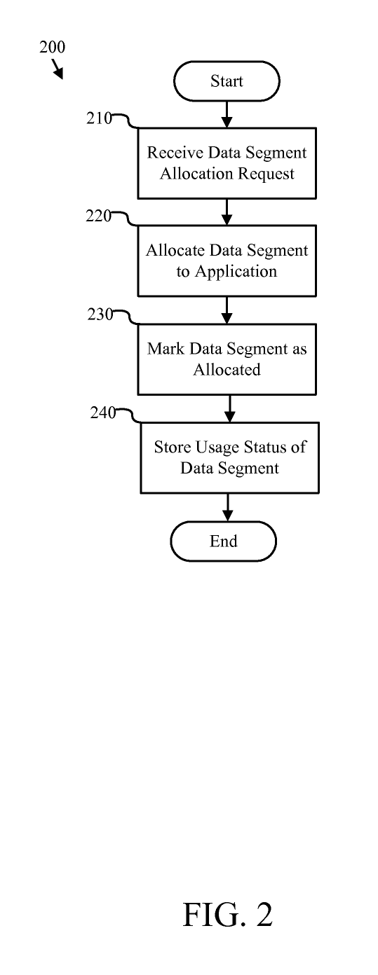

FIG. 2 is a schematic flow chart diagram illustrating one embodiment of a method 200 for managing a data segment in accordance with the present invention. As depicted the method 200 includes the operations of receiving 210 a data segment allocation request, allocating 220 the data segment to the application, marking 230 the data segment as allocated, and storing 240 a usage status of the data segment. The operations of the method 200 depict one approach to managing a data segment.

Receiving 210 a data segment allocation request may include a database management system receiving a data segment allocation from an application that creates temporary table using one or more data segments. Allocating 220 a data segment to the application may include the database management system allocating one or more data segments to the application in accordance with the data segment allocation request. Allocating 220 preferably includes prohibiting other applications from gaining access to the data segment until the data segment is unallocated. In certain embodiments, a data segment may correspond to one or more database pages.

Marking 230 the data segment as allocated may include the database management system marking the data segment as allocated within a space map page in order to prevent other applications from gaining access to the data segment. In some embodiments, the space map page includes a list of all the data segments in the database management system available for usage as well as a list of status indicators (such as an allocation status, a usage status, and an availability status) for each data segment. Storing 240 a usage status of the data segment may include storing a usage status of the data segment in the space map page to represent usage of the data segment by the application.

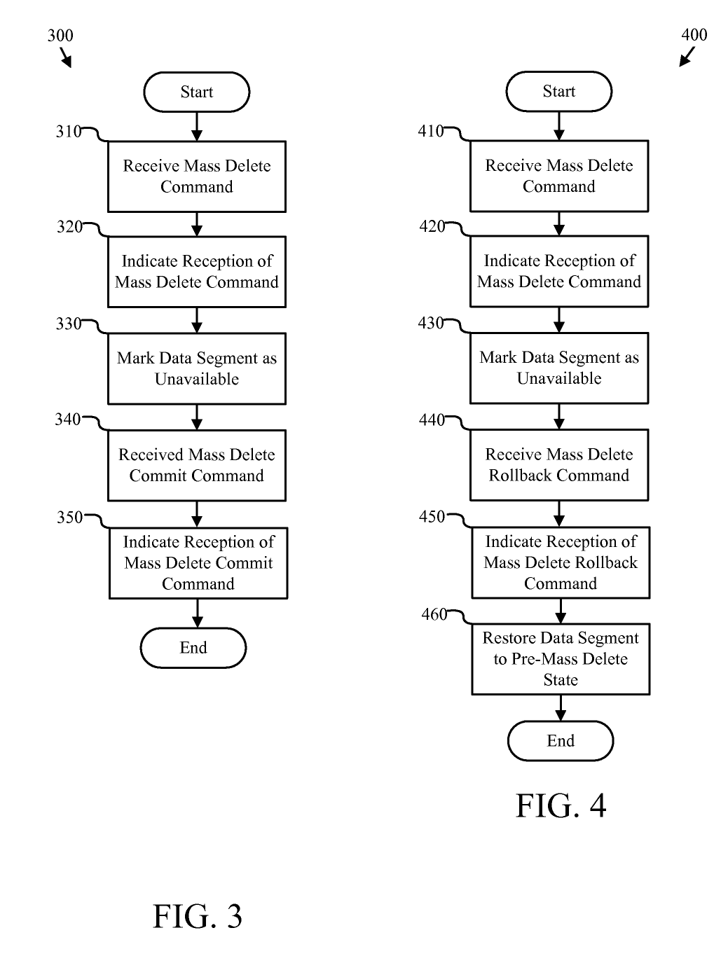

FIG. 3 is schematic flow chart diagram illustrating one embodiment of a method 300 for managing a data segment during a mass delete operation in accordance with the present invention. The depicted method 300 includes receiving 310 a mass delete command, indicating 320 reception of the mass delete command, marking 330 a data segment as unavailable, receiving 340 a mass delete commit command, and indicating 350 reception of the mass delete commit command. The operations of the method 300 depict one approach to managing a data segment undergoing a mass delete command.

Receiving 310 a mass delete command may include receiving 310 a mass delete command that corresponds to a data segment that has been allocated to an application. Indicating 320 reception of the mass delete command may include indicating reception of the mass delete command in a table-related control block. The table related control block may include a record of commands sent from the application to the database management system corresponding to a temporary table created by the application using a data segment.

Marking 330 the data segment as unavailable may include marking the data segment as unavailable in a space map page to prohibit the application from using the data segment as the mass delete command has not been committed or rolled back. In certain embodiments, marking 300 the data segment as unavailable includes marking the data segment as empty by mass delete. It should be noted that marking 330 the data segment as unavailable does not deallocate the data segment. In other words, even when the data segment is unavailable for use by the application the data segment will not be used or allocated to any other application until the data segment is deallocated.

Receiving 340 a mass delete commit command may include the database management system receiving a mass delete commit command from the application that corresponds to the mass delete command previously received. Indicating 350 reception of the mass delete commit command may include indicating reception of the mass delete commit command within the table-related control block to enable the application to reuse the data segment. Accordingly, the method 300 enables one approach to managing a data segment undergoing a mass delete operation.

FIG. 4 is a schematic flow chart diagram illustrating one embodiment of a method 400 for managing a data segment during a mass delete rollback operation in accordance with the present invention. The depicted method includes the operations of receiving 410 a mass delete command, indicating 420 reception of the mass delete command, marking 430 the data segment as unavailable, receiving 440 a mass delete rollback command, indicating 450 reception of the mass delete rollback command, and restoring 460 the data segment. The operations of the method 400 depict one approach to managing a data segment undergoing a mass delete rollback operation.

A comparison of the operations of FIGS. 3 and 4 shows that the operations 410, 420, and 430 directly correspond to the already described operations of 310, 320, and 330. Accordingly, for a description of operations 410, 420, and 430, please reference the description above corresponding to operations 310, 320, and 330.

Receiving 440 a mass delete rollback operation may include the database management system receiving a mass delete rollback command from an application and corresponding to the mass delete command already received in operation 410. The depicted method 400 continues by indicating 450 reception of the mass delete rollback command may include indicating reception of the mass delete rollback command in a table-related control block in volatile memory. Restoring 460 the data segment may include restoring the space map page, with respect to the data segment, to a pre-mass delete state to enable the space map page to continue working with the data segment without losing any data due to the mass delete command. Accordingly, the method 400 depicts an efficient and effective solution for managing a data segment during a mass delete rollback operation.

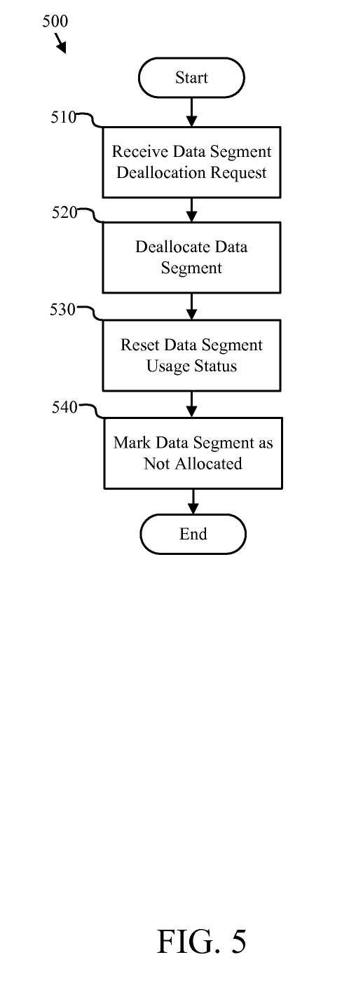

FIG. 5 is a schematic flow chart diagram illustrating one embodiment of a method 500 for deallocating a data segment in accordance with the present invention. The depicted method 500 includes the operations of receiving 510 a data segment deallocation request, deallocating 520 the data segment, resetting 530 the data segment usage status, and marking 540 the data segment as not allocated. The operations of the method 500 deallocate a data segment to enable reallocation of the data segment to another application.

Receiving 510 a data segment deallocation request may include a database management system receiving a data segment deallocation request corresponding to a data segment allocated to an application. Deallocating 520 the data segment may include the database management system deallocating the data segment from the application. Deallocating 520 may also include prohibiting the application from writing data to the data segment.

Resetting 540 the data segment usage status may include setting the data segment usage status in the segment map page to reflect no usage of the data segment. Marking 550 the data segment as not allocated may include the database management system marking that the data segment is not allocated in the space map page. Marking 550 the data segment as not allocated enables the database management system to reallocate the data segment to the same or another application upon reception of a data segment allocation request.

In certain embodiments, the database management system may actually perform method 500 in response to receiving a mass delete commit command from the application instead of waiting to receive 510 a data segment deallocation request. Doing so, enables the database management system to allocate and reallocate data segments more often to better ensure that each application is allocated a proper amount of memory space. Accordingly, such an embodiment would perform operations 520, 530, and 540, in response to receiving a mass delete commit command from the application.

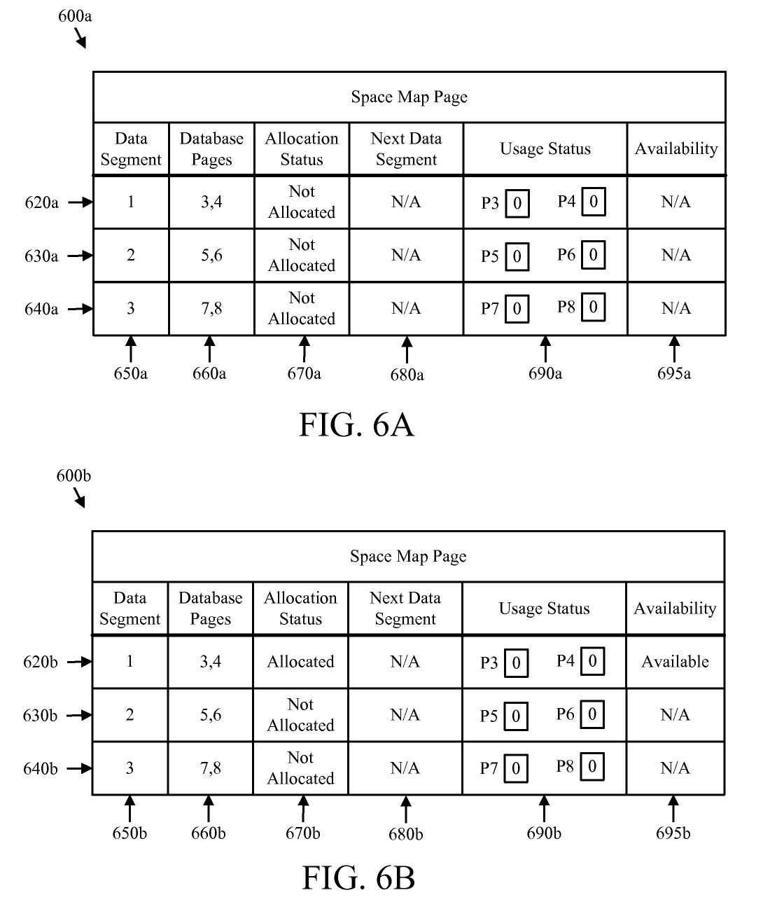

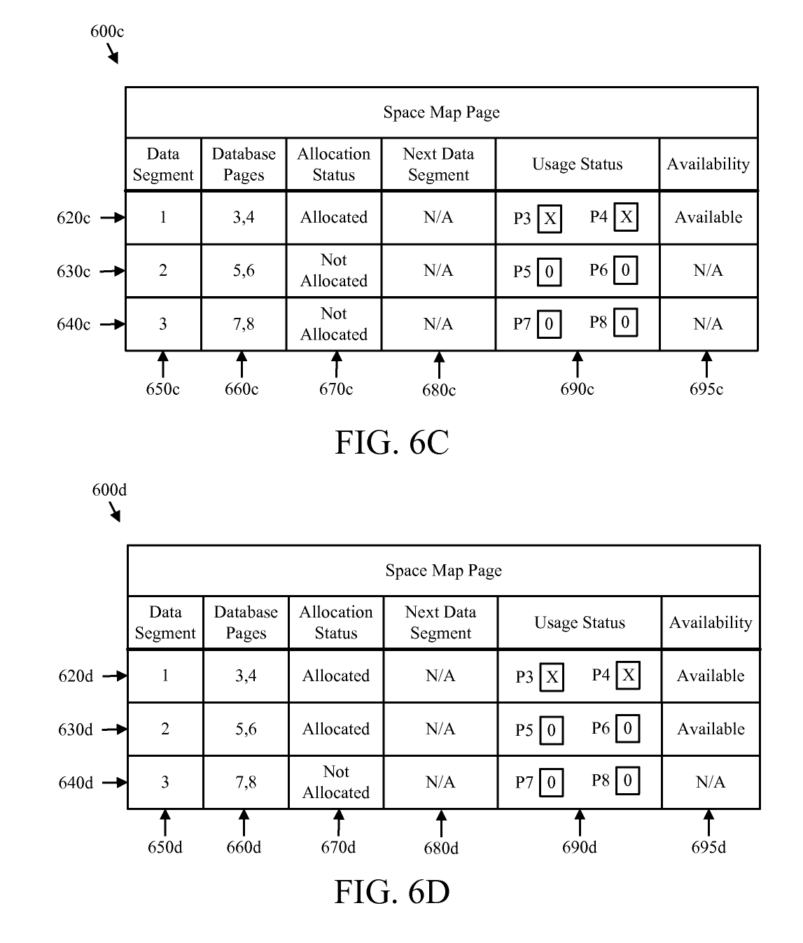

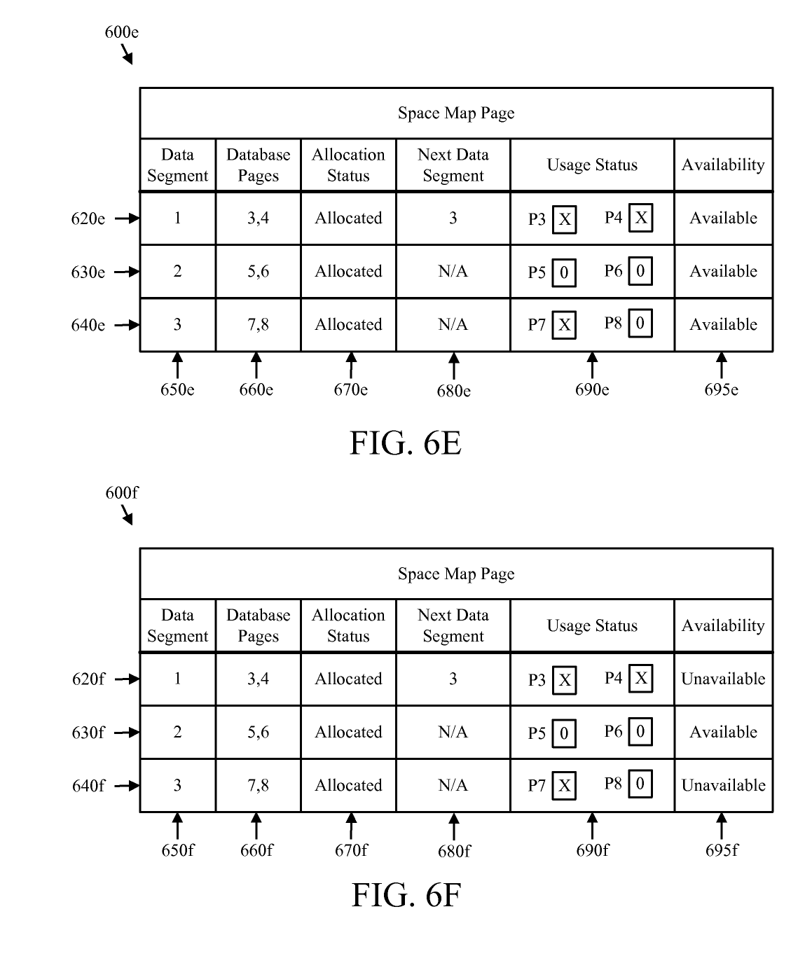

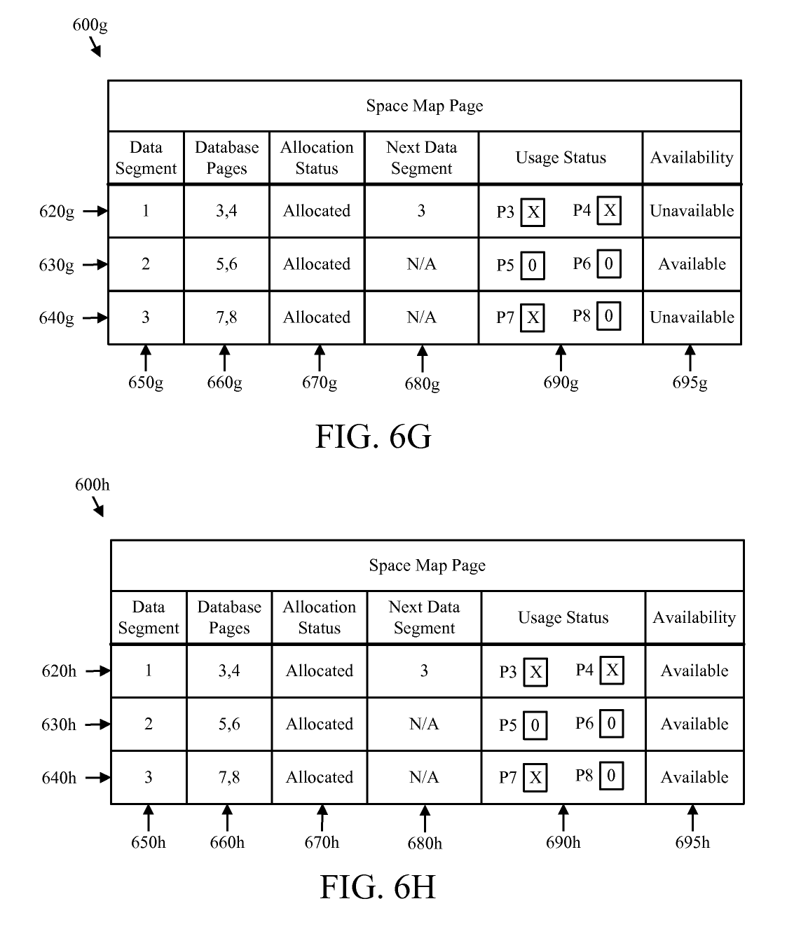

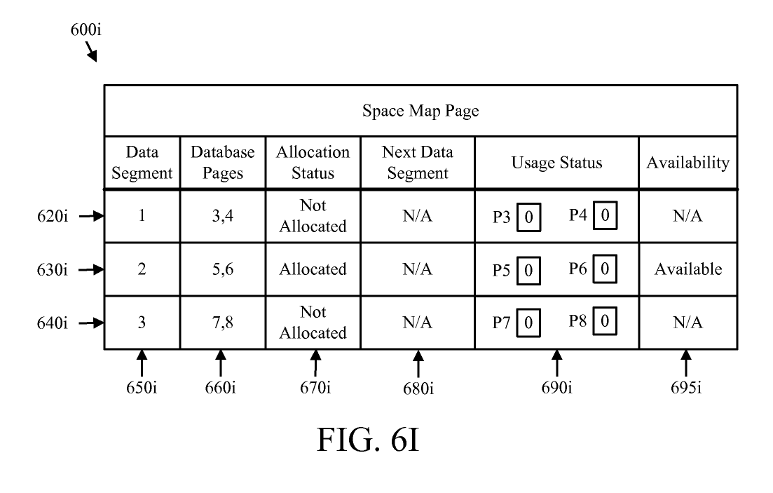

FIGS. 6A-6I are text diagrams illustrating one embodiment of a space map page 600 in different states 600a-600i of change. The space map page 600 depicted in FIGS. 6A-6I represent only one of many possible embodiments of a space map page in accordance with the present invention. Viewed sequentially, FIGS. 6A-6I illustrate states 600a-600i of change that a space map page 600 may undergo as a data segment undergoes allocation, usage, a mass delete commit operation, a mass delete rollback operation, and a data segment deallocation operation.

The depicted space map page 600 includes three rows 620, 630, and 640 that each correspond to a data segment. The depicted space map page 600 also includes a data segment column 650, a database pages column 660, an allocation status column 670, a next data segment column 680, a usage status column 690, and an availability column 695.

The data segment column 650 includes an identifier for each data segment. For example, in FIG. 6A, row 620a includes a data segment identifier “1” in the data segment column 650a. In the depicted space map page 600, data segment 1 of row 620 corresponds to pages 3 and 4 instead of pages 1 and 2 because it is assumed that database page 1 is used for database page organization and administration data and database page 2 is used for the space map page 600.

The database pages column 660 indicates the database pages corresponding to each data segment. The allocation status column 670 indicates an allocation status for each data segment. The next data segment column 680 indicates whether any of the data segments are part of a chain of data segments. The usage status column 690 indicates a usage status of each data segment. For example, the usage status for data segment 1 of row 620a includes a “P3” and “P4” representing database page 3 and database page 4 respectively. In certain embodiments, the database pages may begin with database page 0 instead of database page 1. The availability column 695 indicates whether a data segment is available for use.

One of skill in the art will note that certain attributes of the space map page 600 may be implied instead of physically represented in the space map page. For example, the availability column 695 and database pages column 660a of a data segment may be implied by the usage status of the data segment and the usage status may be expressed in a bitmap. Similarly, the data segment column 650 may be implied by the physical description and location of the actual data segment. Accordingly, the space map page depicted in FIG. 6A-6I are intended to more clearly illustrate the information that may be directly or indirectly ascertained by the physical state of the space map page.

usage status 690 may be described by a bitmap the availability status column 695 may be implied from the usage status the space map page 600 does not include a physical description of each

FIG. 6A is a text diagram illustrating the space map page 600 in a state 600a where the depicted data segments that have not been allocated or used by any application. As none of the data segments in the space map page 600 in state 600a have been allocated to an application, the allocation status of column 670a indicates “Not Allocated” which notifies the database management system that any of the data segments may be allocated to an application in response to receiving a data segment allocation request.

Also, the next segment column 680a indicates an “N/A” status for all data segments as none of the data segments currently correspond to a data segment chain. Each database page represented in the usage status column 690a corresponds to a usage status of “0” which represents no usage. Finally, the availability column 695a indicates a “N/A” status as none of the data segments of rows 620a, 630a, or 640a are currently available for usage as none of the data segments have been allocated.

When a data segment allocation request is received, the database management system may identify the first data segment in the space map page 600 that is not allocated. In this case, the data segment of row 620a was not allocated and is located at the top of the data segment column 650a. Accordingly, referring to FIG. 6B, the data segment of row 620b is allocated to the application in response to the data segment allocation request and the data segment of row 620b now indicates an “Allocated” status in the allocation status column 670b. The “Allocated” status prohibits the database management system from allocating the data segment of row 620b to another application. Also, the availability status of column 695b is set to “Available” to indicate that the data segment of row 620a is available to be used by the application to create a temporary table.

Referring now to FIG. 6C, as the application uses the data segment of row 620c, the space map page 600 in state 600c is updated to indicate the usage of the data segment. For example, if the application uses all the memory space of database pages 3 and 4, the usage status cell of column 690c and row 620c is updated to reflect usage of the database pages. Accordingly, “P3” and “P4” in the usage status column 690c now include an “X” to indicate that database pages have been used by the application.

When the database management system receives a data segment allocation request from an additional application, the database management system may browse the space map page 600 in state 600c for the next data segment that is not allocated. Accordingly the data segment of row 630c indicated a “Not Allocated” status in the allocation status column 670c (see state 600c in FIG. 6C). Therefore, referring to FIG. 6D, the database management system may allocate the data segment of column 630d to the additional application and indicate an “Allocated” status in the allocation status column 670c corresponding to the data segment of row 630c. The availability status of column 695d and row 630d may be changed to “Available” to enable the application to use the data segment of row 630d.

Referring to FIG. 6E, if the database management system receives an additional data segment allocation request from the first application, the database management may allocate an additional data segment to the application. The additional data segment allocated to the application is the next not allocated data segment—the data segment of row 640d (see FIG. 6D). Accordingly, the allocation status of column 670e and row 640e indicates an “Allocated” status.

Also, the data segment of row 620e which has already been allocated to the application is updated to reflect a “3” in the next data segment column 680e to associate the data segment of row 620e with the data segment of row 640e to create a data segment chain. If the application uses the data segment of row 640e, the usage status of column 690e is updated. In this example, the application only uses database page 7 represented by “P7” in the usage status column 690e.

Referring to FIG. 6F, when the database management system receives a mass delete command from the application the space map page 600 in may be updated to reflect the mass delete command. More specifically, the availability column 695f for row 620f and 640f may be changed to “Unavailable” to prohibit the application from using the data segments of 620f and 640f. If there application were to require more data segments, the application would communicate additional data segment allocation requests and the database management system would allocate additional data segments (assuming there were more to allocate) in a fashion similar to that illustrated by the current sequence of Figures.

Referring to FIG. 6G, if a mass delete commit command is received the space map page may not change because reception of the mass delete commit command is recorded in the table-related control block. This enables the application to completely reuse the data segments of row 620e and 640e. As such, indicating reception of the mass delete commit command in the table-related control block may, in a sense, override the availability status indicated in the space map page. In other words, if the table-related control block indicates the mass delete is committed, the application may reuse the data segment even if the data segment is indicated as unavailable in the space map page.

Referring to FIG. 6H, if a mass delete rollback command were received instead of a mass delete commit command, the space map page 600 in state 600h would reflect the mass delete rollback command by changing the “Unavailable” status of column 695f (see FIG. 6F) to “Available” as seen in FIG. 6H. Making such changes to the space map page may be part of a restore operation that restores the space map page, with respect to the data segment under consideration, to a pre-mass delete command state as depicted by FIG. 6E. This would undo the mass delete command and enable the application to continue to use the data segments without reflecting a loss of data.

Referring to FIG. 6I, if the database management system receives a deallocation request from the application, the database management system may update the space map page 600i accordingly. The allocation status column of 670i and rows 620i and 640i are changed to “Not Allocated”. The usage status of column 690i and rows 620i and 640i are reset to “0” to reflect no usage. And, the availability column 695i for rows 620i and 640i are changed to “N/A” to reflect deallocation. Accordingly, the present invention enables data segment allocation and management, mass delete operation, mass delete rollback operation, and data segment deallocation and reallocation without any unnecessary data segment lock-downs.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product for managing temporary storage space of a relational database management system, wherein the computer program product when executed on a relational database management system causes the relational database management system to:
receive a data segment allocation request from an application;
allocate a data segment to the application, the data segment corresponding to at least one database page;
mark the data segment as allocated and available in a space map page;
store a usage status of the data segment in the space map page to represent usage of the data segment by the application;
receive a mass delete command from the application corresponding to the data segment and indicate reception of the mass delete command in a table-related control block configured to maintain a record of commands received from the application;
mark the data segment as unavailable in the space map page to prohibit the application from altering the data segment; and
in response to a mass delete rollback command provided by the application, indicate reception of the mass delete rollback command in the table related control block and restore the space map page with respect to the data segment to a pre-mass delete command state to enable the application to continue using the data segment.

2. The computer program product of claim 1, wherein the computer readable program is further configured to cause the relational database management system to indicate reception of the mass delete commit command in the table-related control block to enable the application to reuse the data segment, in response to a mass delete commit command provided by the application.

3. The computer program product of claim 2, wherein the computer readable program is further configured to cause the relational database management system to mark the data segment as not allocated and unused in the space map page in response to receiving a data segment deallocation request from the application.

4. The computer program product of claim 3, wherein the computer readable program is further configured to cause the relational database management system to indicate, in the space map page, that the at least one additional data segment is part of a data segment chain comprising the data segment and the at least one additional data segment.

5. The computer program product of claim 1, wherein the computer readable program is further configured to cause the relational database management system to the data segment as not allocated and unused in the space map page in response to receiving a mass delete commit command provided by the application.

6. The computer program product of claim 1, wherein the computer readable program is further configured to cause the relational database management system to allocate the at least one additional data segment to the application and mark the at least one additional data segment as allocated and available in the space map page in response to receiving at least one additional data segment request from the application.

7. The computer program product of claim 1, wherein the computer readable program is further configured to cause the relational database management system to update an object descriptor record with table attribute data in response to creation of a temporary table.

8. A system for managing temporary storage space of a relational database management system, the system comprising:
a processor in communication with memory comprising:
a communication module configured to receive a data segment allocation request from an application;
an allocation module configured to allocate at least one data segment to the application, the at least one data segment corresponding to at least one database page;
a space map page module configured to mark the data segment as allocated and available in a space map page;
the space map page module further configured to store a usage status of the data segment in the space map page that represents usage of the data segment by the application;
the communication module further configured to receive a mass delete command corresponding to the data segment from the application;
a control block module configured to indicate reception of the mass delete command in a table-related control block, the table-related control block configured to maintain a record of commands received from the application;
the space map page module further configured to mark the data segment as unavailable in the space map page in order to prohibit the application from altering the data segment;
the control block module further configured to indicate reception of a mass delete commit command in the table-related control block, in response to the communication module receiving a mass delete commit command from the application;
the control block module further configured to indicate reception of a mass delete rollback command in the table related control block and the space map page module further configured to restore space map page with respect to the data segment to a pre-mass delete command state, in response to the communication module receiving a mass delete rollback command from the application; and
the space map page module further configured to mark the data segment as not allocated and unused in the space map page in response to the communication module receiving a data segment deallocation request from the application.
